(19) United States
(12) Patent Application Publication
(10) Pub. No.: US 2015/0248253 A1
(43) Pub. Date: Sep. 3, 2015

(54) Intelligent Distributed Storage Service System and Method

(71) Applicant: Hyosung ITX Co., Ltd, Seoul (KR)

(72) Inventors: Tae Hoon Kim, Seoul (KR); Yong Kwang Kim, Seoul (KR)

(21) Appl. No.: 14/427,503

(22) PCT Filed: Sep. 11, 2013
(86) PCT No.: PCT/KR2013/008198

§ 371 Date: Mar. 11, 2015

(30) Foreign Application Priority Data
Sep. 13, 2012 (KR) 10-2012-0101780

(51) Int. Cl. G06F 3/06; G06F 17/30

(52) U.S. Cl. CPC G06F 3/0626; G06F 17/30864; G06F 17/3053; G06F 3/0643; G06F 3/0665; G06F 3/067

(57) ABSTRACT

Disclosed is an intelligent distributed storage service system comprising: a web server configured to receive selection information including a virtual storage capacity necessary for a virtual storage service, the number of storage nodes, storage node types, and a distribution method from the terminal when the terminal requests the virtual storage service; at least one storage node configured to generate a virtual disk volume according to external control; a control center server configured to monitor available capacities and usage states of the storage nodes, determine a storage node corresponding to the selection information among the monitored storage nodes, and control the determined storage node to generate the virtual disk volume; and a database (DB) configured to store information of the storage node and virtual disk volume information of the user.

### TECHNICAL FIELD

The present invention relates to a control computing technology, and more particularly, to an intelligent distributed storage service system and method.

### BACKGROUND ART

As control computing is generally raised as an issue, a distributed file system on which control computing is based is under active research.

Most distributed file systems are widely used due to their advantages that it is easy to share information among users and it is possible to efficiently use a storage space while reducing spatial limitations.

Such a distributed file system has characteristics as described below.

Most large-capacity file systems used in existing control environments are directory-based file systems.

Regardless of the types of local file systems of actual nodes, data is divided into chunks (or blocks) having a designated size in a directory designated among several distributed storage nodes and spread over all nodes in a distributed manner.

Also, the spread chunks are replicated through a pipeline two or more times among nodes.

However, since a user (or an administrator) cannot know where personal information and data spread in a distributed manner are stored, such an existing distributed file system has the risk of loss and infringement of stored information.

According to an existing method, during a disk backup of user data, data duplication cannot be avoided. In order to avoid such data duplication, it is necessary to remove data and download the data onto another disk or a server in a separate method used by a user, which is a complex and inconvenient process.

Also, most distributed file systems perform balancing for resolving an imbalance in the amount of disk use, but it is not possible to measure the degree of imbalance at this time. Also, rebalancing is performed on all disks so that overhead may occur.

Meanwhile, according to an existing distributed storage method, data is stored in all registered data nodes in a distributed manner using a round-robin method (which is not a method performed using a special algorithm but a method of equally storing data in all servers), and data reading is generally performed at stored locations in a distributed manner.

This is the same for even a case in which a storage for a new user is generated (i.e., data is present at all data nodes).

Here, when computing capabilities of server equipment used at all data nodes are not identical, all the pieces of server equipment have the latency of the poorest node (because distribution/replication is made to all the data nodes).

For this reason, even when computing capabilities of server equipment used at all data nodes are satisfied, a network load and usage rates of a central processing unit (CPU) and a memory vary according to situations and application situations (i.e., execution environments).

Therefore, the original aim of a distributed file system and storage virtualization, that is, the purpose of ensuring high performance and high availability by disposing low-specification storage equipment in a distributed manner may not be achieved.

### DISCLOSURE

### Technical Problem

The present invention is directed to providing an intelligent distributed storage service system and method capable of achieving the original aim of a distributed file system and storage virtualization, that is, to ensure high performance and high availability by disposing low-specification storage equipment in a distributed manner even when computing capabilities of server equipment used at all data nodes are different or a network load and usage rates of a central processing unit (CPU) and a memory vary according to situations and application situations (i.e., execution environments).

The present invention is also directed to providing an intelligent distributed storage service system and method that propose a fundamental solution to the risk of loss and infringement of information stored in device volumes, and propose a method of performing a volume snapshot backup excluding duplicated data according to users by assigning user-specific distribution nodes to device volumes.

The present invention is also directed to providing an intelligent distributed storage service system and method capable of measuring the degree of imbalance in the amount of disk use according to volumes allocated to users, and reducing overhead by performing rebalancing according to the allocated volumes.

### Technical Solution

One aspect of the present invention provides a block device-based intelligent distributed storage service system which is an intelligent distributed storage service system connected to at least one user terminal through a network comprising: a web server configured to receive selection information including a virtual storage capacity necessary for a virtual storage service, a number of storage nodes, storage node types, and a distribution method from the terminal when the terminal requests the virtual storage service; at least one storage node configured to generate a virtual disk volume according to external control; a control center server configured to monitor available capacities and usage states of the storage nodes, determine a storage node corresponding to the selection information among the monitored storage nodes, and control the determined storage node to generate the virtual disk volume; and a database (DB) configured to store information of the storage nodes and virtual disk volume information of the user.

When the terminal requests the virtual storage service, the web server may request the terminal to input a necessary virtual storage capacity, storage node types to be generated, a number of storage nodes, and a distribution method, and when the virtual storage capacity, the storage node types, the number of storage nodes, and the distribution method are input from the terminal, the web server may transfer the input information to the control center server.

The control center server may calculate a capacity required by the respective storage nodes by dividing the input capacity by the number of necessary storage nodes, determine the storage node corresponding to the selection information among nodes having capacities that are 1.5 times or more the capacity required by the respective storage nodes, and control the determined storage node to generate the virtual disk volume.

The control center server may calculates values by multiplying an available capacity, a disk input and output (I/O) average ranking, a central processing unit (CPU) usage rate average ranking, a memory usage rate, and a network I/O average ranking of each storage node by weights using the available capacities and the usage states of the storage nodes, adds the values, determine a storage node to configure a virtual storage according to rankings of sums of products, and control the determined storage node to generate the virtual disk volume.

The control center server may control the determined storage node to generate the virtual disk volume, and the determined storage node may generate the virtual disk volume.

Another aspect of the present invention provides an intelligent distributed storage service method which is an intelligent distributed storage service method connected to at least one user terminal through a network comprising: requesting, by the terminal, a virtual storage service from a web server; receiving, by the web server, selection information including a virtual storage capacity necessary for the virtual storage service, a number of storage nodes, storage node types, and a distribution method from the terminal; calculating, by a control center server, a capacity required by the respective storage nodes by dividing the input virtual storage capacity by the number of necessary storage nodes with reference to the selection information; determining, by the control center server, a storage node corresponding to the selection information among nodes having capacities that are 1.5 times or more the capacity required by the respective storage nodes; controlling, by the control center server, the determined storage node to generate a virtual disk volume; and generating, by the determined storage node, the virtual disk volume according to the control of the control center server.

The determining of the storage node corresponding to the selection information may comprise calculating values by multiplying an available capacity, a disk I/O average ranking, a CPU usage rate average ranking, a memory usage rate, and a network I/O average ranking of each storage node by weights using available capacities and usage states of the storage nodes, and adding the values; and determining a storage node having a sum whose ranking is included in rankings of the number of necessary storage nodes as a storage node to configure a virtual storage, and controlling the determined storage node to generate the virtual disk volume.

The method may further include storing, by the control center server, information on the generated virtual disk volume of the user in a DB.

The receiving of the selection information by the web server may include: when the terminal requests the virtual storage service, requesting the terminal to input a necessary virtual storage capacity, storage node types to be generated, a number of storage nodes, and a distribution method; and when the virtual storage capacity, the storage node types, the number of storage nodes, and the distribution method are input from the terminal, transferring the input information to the control center server.

### Advantageous Effects

Exemplary embodiments of the present invention propose a fundamental solution to the risk of loss and infringement of information stored in device volumes, and make it possible to perform a volume snapshot backup excluding duplicated data according to users by assigning user-specific distribution nodes to device volumes.

Also, it is possible to measure the degree of imbalance in the amount of disk use according to volumes allocated to users, and reduce overhead by performing rebalancing according to the allocated volumes.

In addition, even in the case of data having a different standard of specifications of a node storage, etc. than other data, it is possible to calculate a result of addition based on the same standard. Also, by applying weights to respective factors, data to be considered with priority is reflected in the result of addition and can be disposed in an objectively appropriate environment in a distributed manner.

Further, since data is distributed to storage nodes which use a small amount of resources and processed, it is possible to ensure high performance and high availability by disposing low-specification storage equipment in a distributed manner.

### DESCRIPTION OF DRAWINGS

FIG. 1 is a configuration diagram of an intelligent distributed storage service system according to an exemplary embodiment of the present invention.

FIG. 2 is a diagram illustrating a storage pool forming process in an intelligent distributed storage service method according to an exemplary embodiment of the present invention.

FIG. 3 is a diagram illustrating a storage monitoring process in an intelligent distributed storage service method according to an exemplary embodiment of the present invention.

FIG. 4 is a diagram illustrating a storage node selection process in an intelligent distributed storage service method according to an exemplary embodiment of the present invention.

FIG. 5 is a diagram illustrating an example of determining rankings of storage nodes in an intelligent distributed storage service method according to an exemplary embodiment of the present invention.

### MODES OF THE INVENTION

Hereinafter, exemplary embodiments of the present invention will be described in detail with reference to the accompanying drawings so that those of ordinary skill in the art to which the present invention pertains can easily carry out the embodiments. However, exemplary embodiments of the present invention shown as examples below can be modified in various other forms, and the scope of the present invention is not limited to the exemplary embodiments described below. In order to clarify the present invention, parts which are not related with the description will be omitted from the drawings, and like reference numbers will be used to refer to like parts throughout the drawings.

When a part is referred to as “including” an element in this specification, it means that the part can further include other elements unless mentioned to the contrary. Also, terminology “ . . . portion,” “ . . . part,” “module,” etc. used herein means a unit processing at least one function or operation, and can be implemented by hardware, software, or a combination of hardware and software.

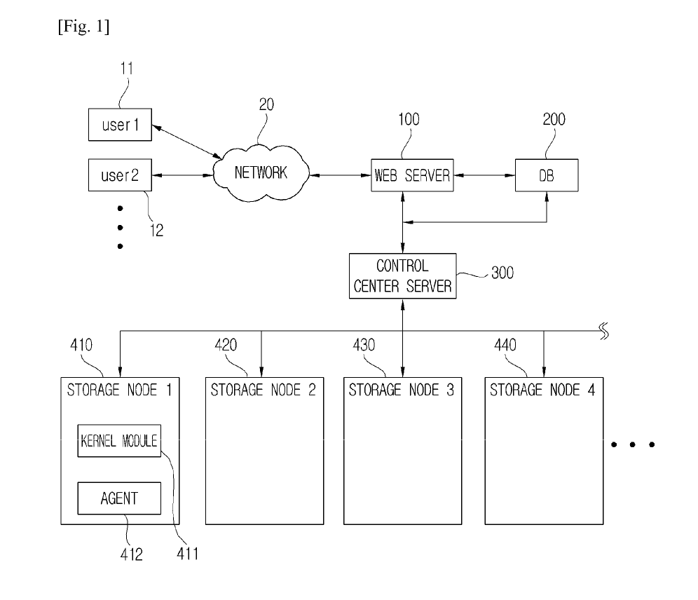

FIG. 1 is a configuration diagram of a block device-based virtual storage service system according to an exemplary embodiment of the present invention.

Referring to FIG. 1, the block device-based virtual storage service system according to an exemplary embodiment of the present invention is a virtual storage service system connected to at least one of user terminals 11 and 12 through a network 20, and the virtual storage service system comprises a web server 100, a control center server 300, storage nodes 410, 420, 430, and 440, and a database (DB) 200.

When the terminal 11 or 12 requests a virtual storage service, the web server 100 requests the terminal 11 or 12 to input selection information including a necessary virtual storage capacity, storage node types to be generated, the number of storage nodes, and a distribution method. When the virtual storage capacity, the storage node types, the number of storage nodes, and the distribution method are input from the terminal 11 or 12, the web server 100 transfers the virtual storage capacity, the storage node types, the number of storage nodes, and the distribution method to the control center server 300.

The control center server 300 controls a virtual disk volume to be generated with reference to the selection information.

The control center server 300 calculates a capacity required by the respective storage nodes by dividing the input capacity by the number of necessary storage nodes, determines a storage node corresponding to the selection information among nodes having capacities that are 1.5 times or more the capacity required by the respective storage nodes, and controls the determined storage node to generate the virtual disk volume.

The control center server 300 calculates values by multiplying an available capacity, a disk input and output (I/O) average ranking, a central processing unit (CPU) usage rate average ranking, a memory usage rate, and a network I/O average ranking of each storage node by weights using available capacities and usage states of storage nodes, adds the values, determines a storage node to configure a virtual storage according to rankings of the sums, and controls the determined storage node to generate the virtual disk volume.

The control center server 300 controls the determined storage node to generate the virtual disk volume, and the determined storage node generates the virtual disk volume.

The storage nodes 410, 420, 430 and 440 generate virtual disk volumes according to the control of the control center server 300.

The DB 200 stores information of the storage nodes and virtual disk volume of the user.

Operation of the block device-based virtual storage service system having such a configuration according to an exemplary embodiment of the present invention will be described in detail below.

First, equipment (an x86-based server, etc.) of the storage nodes 410, 420, 430 and 440 to be included in a storage pool, in which a kernel module and an agent (software) virtualizing a storage and enabling distributed management of data are installed, is registered based on Internet protocol (IP) addresses.

Subsequently, the storage nodes 410, 420, 430 and 440 are managed by the control center server 300, and metadata for data management (locations/paths of files (directories), etc.) is clustered (shared in real time) at the respective storage nodes 410, 420, 430 and 440. The storage nodes 410, 420, 430 and 440 formed in this way are connected to each other through a network, so that the control center server 300 stores and manages files in a distributed manner. Here, the storage nodes 410, 420, 430 and 440 may be servers, and the number of storage nodes may increase. Also, the number of terminals may increase.

This is referred to as a trusted network. A server group connected in this way is referred to as a storage pool, and each of servers is referred to as a storage node.

A method of forming such a storage pool will be described in detail below.

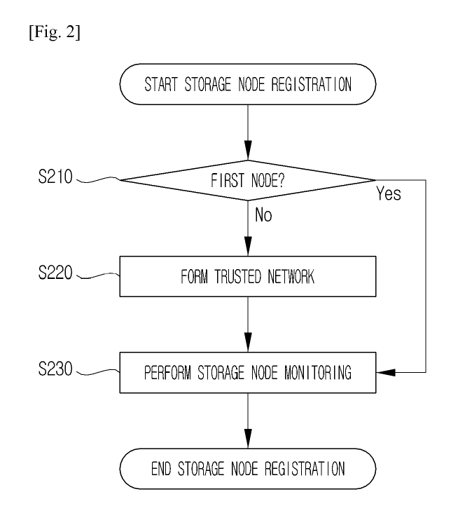

FIG. 2 is a diagram illustrating a storage pool forming process in an intelligent distributed storage service method according to an exemplary embodiment of the present invention.

Referring to FIG. 2, when registration of a storage node is started, the control center server 300 determines whether the storage node is a first node (S210).

When the storage node is a first node, a single pool is formed, and storage node monitoring is performed (S230).

When the storage node is a second or subsequent node, the control center server 300 forms a peer probe, that is, an internal trusted network pipeline, with an existing storage node (S220). Then, storage node monitoring is performed (S230).

Next, a storage monitoring process will be described below.

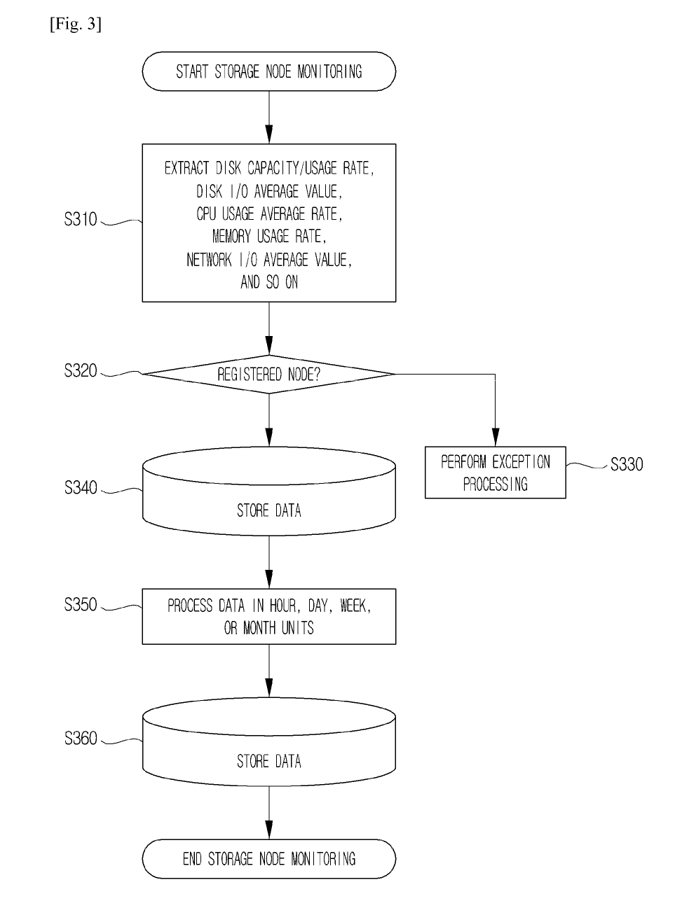

FIG. 3 is a diagram illustrating a storage monitoring process in an intelligent distributed storage service method according to an exemplary embodiment of the present invention.

Referring to FIG. 3, when a network is formed normally, each storage node extracts and transfers an available disk capacity which can be used in a virtual storage, disk I/O, a CPU usage rate, a memory usage rate, network I/O, etc. to the control center server 300 (S310).

The control center server 300 receives the information extracted from the storage node, and determines whether the storage node is a registered storage node (S320).

When the storage node is not a registered storage node, exception processing is performed (S330).

When the storage node is a registered storage node, the received extracted information is stored in the DB 200 together with a storage node identifier (ID) (an IP address, etc.) (S340).

Then, the extracted information collected is processed based on time periods (hour, day, week, or month units) according to each storage node, and stored in the DB 200 (S360).

Subsequently, a storage node selection process is performed as will be described in detail below.

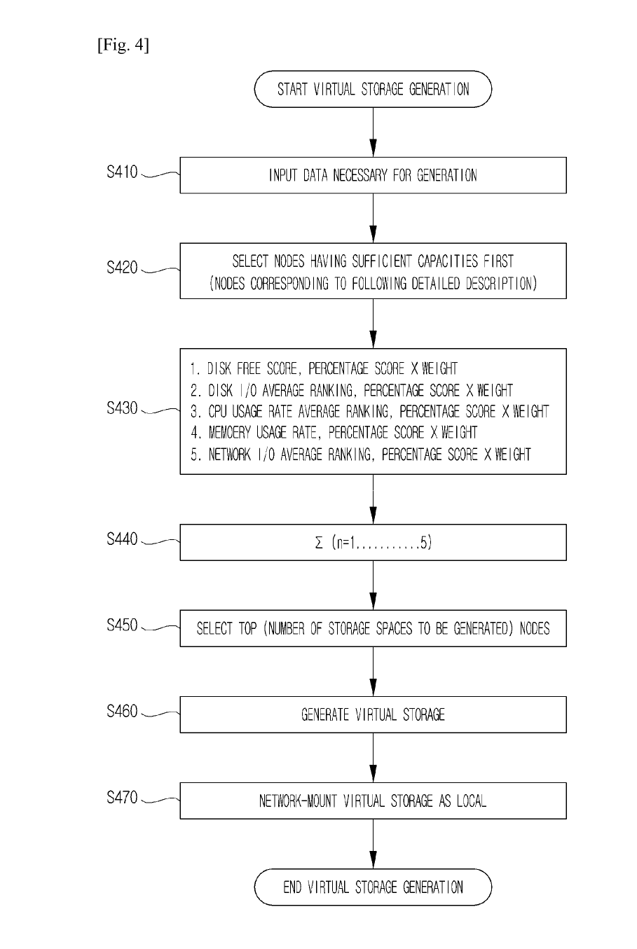

FIG. 4 is a diagram illustrating a storage node selection process in an intelligent distributed storage service method according to an exemplary embodiment of the present invention.

To virtually generate a storage to be used by a user based on a storage pool, the user first accesses the web server 100 through the network 20 using the terminal 11, and requests a virtual storage service from the web server 100.

When the terminal 11 requests the virtual storage service, the web server 100 requests the terminal 11 to input a virtual storage capacity to be generated, storage node types, the number of storage nodes, and a distribution method.

At this time, after a virtual storage capacity and storage node types are input, the number of storage nodes and a distribution method can be input in sequence. Such a sequence may vary as required.

Next, when a virtual storage capacity to be generated, storage node types, the number of storage nodes, and a distribution method are input from the terminal 11 (S410), the control center server 300 selects storage nodes having sufficient capacities according to the virtual storage capacity to be generated, the storage node types, the number of storage nodes, and the distribution method (S420). Nodes having capacities which are 1.5 times or more a capacity required by the respective storage nodes may be selected as storage nodes having sufficient capacities, or storage nodes having sufficient capacities may be selected in another way.

For example, nodes satisfying the following condition are selected.

[Capacity currently remaining in node]>[Total capacity of virtual storage to be generated/(Number of storage spaces to be generated/Number of replications)] However, when the number of replications is zero, the division is not performed.

When storage nodes having sufficient capacities are selected in this way, the control center server 300 calculates values by multiplying an available capacity, a disk I/O average ranking, a CPU usage rate average ranking, a memory usage rate, and a network I/O average ranking of each of the storage nodes having sufficient capacities by weights (S430), adds the values (S440), determines storage nodes having sums of the values whose rankings are included in rankings of the number of necessary storage nodes as storage nodes which will configure a virtual storage (S450), and controls the determined storage nodes to generate a virtual disk volume (S460).

Such a storage node determination process of the control center server 300 will be described in further detail below.

Here, the weights are constants for weighting the corresponding factors among disk usage, disk I/O, network I/O, CPU usage, and memory usage so that the corresponding factors work as more important factors.

Among the storage nodes having sufficient capacities, percentage scores x weights are calculated by Equation 1 below.

1. Disk free score=(Disk free÷Disk total)×100×Weight 1

2. Disk I/O score=(100−(Disk I/O average ranking÷Total number of storage nodes))×100×Weight 2

3. Network I/O score=(100−(Network I/O average ranking÷Total number of storage nodes))×100×Weight 3

4. CPU usage score=(100−CPU usage average rate)×Weight 4

5. Memory usage score=((Free size+Cached size)÷Total size) average value×100×Weight 5 [Equation 1]

“Free size+Cache size” denotes an actually available memory size, and in case of need, a swap (virtual memory) usage rate can also be included. Here, Equation 1 above can be modified diversely, and each weight can also be given differently as required.

Σ(n=1, . . . , 5): The sum of No. 1 to No. 5 is calculated.

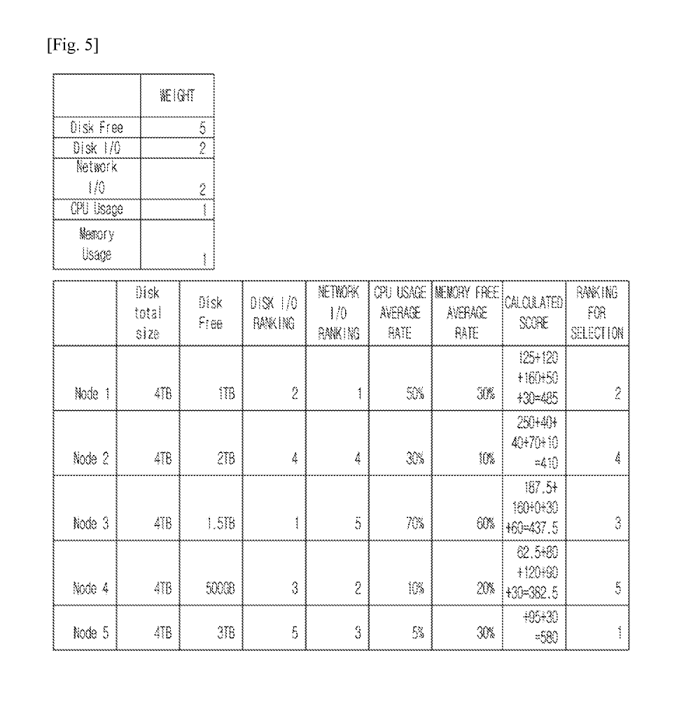

Then, according to the number of storage nodes to be generated, storage nodes (as many as the number of selection nodes) are selected in order of high score. In other words, when it is necessary to generate four storage nodes, four storage nodes are determined in order of high score as storage nodes corresponding to selection information. An example of rankings calculated at this time is shown in FIG. 5.

Referring to FIG. 5, rankings are determined according to results of disk usage, disk I/O, network I/O, CPU usage, and memory usage of storage node 1 to storage node 5 calculated by the equation. Then, storages of ranking Nos. 1 to 4 are determined as storage nodes corresponding to selection information.

When storage nodes corresponding to selection information are determined through the above process, the control center server 300 outputs a control signal so that the storage nodes determined as the storage nodes corresponding to the selection information generates virtual disk volumes.

Then, according to the control of the control center server 300, the determined storage nodes generate virtual disk volumes.

Subsequently, the generated virtual disk volumes are mounted on the user terminal 11 through export and import processes. In other words, the generated virtual disk volumes of the storage nodes are network mounted on the terminal 11 of the user and used as a local storage device (S470).

Next, the control center server 300 stores information on the generated virtual disk volumes of the user in the DB.

Here, a method of generating the volumes varies according to a distribution method. Storage distribution methods used in the present invention are as follows.

Distributed (D): In this method, respective files are distributed in whole to respective nodes. This method is mainly advantageous when there are a large number of small-capacity files such as document files.

Stripe (S): In this method, each file is divided into chunks of a determined size, stored, and read. This method is mainly advantageous for large-capacity files, such as video media files, when it is intended to ensure a large number of simultaneous readings.

Replication (R): In this method, each file is replicated and stored in a determined node. This method is mainly used to ensure stability of stored files and support a non-stop service.

Distributed Stripe (DS): D+S: This method is mainly used to add a volume to a virtual storage that has already been present as a stripe (scale-out).

Distributed Replication (DR): D+R: This method is mainly used to add a volume to a virtual storage that has already been present as a replication (scale-out).

Striped Replication (SR): S+R: This method is mainly used for large-capacity files and simultaneously to ensure stability of data.

Distributed Striped Replication (DSR): D+S+R: This method is a combined configuration of the above methods.

In the above virtualization methods, the numbers of Ds, Ss, or Rs can be set, and according to the set numbers, it is possible to know which storage nodes have block devices to which files have been distributed, striped, or replicated.

Distribute nodes are set first, and then stripe nodes and replication nodes are set in sequence. However, in the case of a complex configuration such as DSR, the number of block devices in storage nodes are required to be the number of Ds*the number of Ss*the number of Rs, and the number of Rs is required to increase by an even number. Also, unlike a general distributed file system (in general, filenames are converted into unique values such as hash values), filenames are stored as they are, and thus it is possible to check a file using a filename and a disk usage (du) command.

For example, it is assumed that the following are generated.

When a user virtual storage of 8 TB is generated and a distribution method is SR with 4 Ss and 2 Rs, the number of block devices for the user virtual storage in nodes is 4*2=8.

As eight storage nodes, storage nodes of 192.168.16.11 to 192.168.16.18 can be selected and used. Needless to say, other storage nodes can also be selected as eight storage nodes.

Under the above conditions, 8 TB (total capacity)/(8 (total number of block devices to be generated)/2 (number of replications))=2 TB(capacity to be generated) is generated at each of the eight storage nodes No. 11 to No. 18.

In this way, virtual disk volumes are generated.

Users virtually use virtual disk volumes generated at several storage nodes as one logical volume, and this is the concept of a virtual storage.

Since the S method is first applied to the storage nodes, stripes are applied to half the storage nodes IP Nos. 11 to 14, and the same number of replications are applied to the other storage nodes.

When virtualization is performed thereafter, it is neither possible to physically or logically know where files are distributed nor where file replication is performed in a general distributed file system.

On the other hand, according to an exemplary embodiment of the present invention, even when storage devices (block devices) of the eight different storage nodes are treated as one through virtualization, actually stored data of users is present with filenames as they are in directories in each storage node on which a block device is mounted. However, when data is stored in the Stripe method, filenames will be as they are, but the data will be divided into chunk size and stored. In this case, the data can be checked using the du command, which is one of system calls, or so on. Also, since it is possible to know which node has a block device for replication, the backup of a block device can be performed without duplication. At this time, the backup may be performed by physical third-party equipment, or the aforementioned snapshot backup may be performed.

A snapshot and a backup of a block device are terms well known in this field so detailed descriptions thereof will be omitted.

The virtual disk volumes generated in this way are imported (network mounted) into the terminal of the user and used as a local storage device.

This is also well known in this field so detailed description thereof will be omitted.

In an exemplary embodiment of the present invention, a user (or administrator) can know where his or her virtual storage has been assigned, and also can basically know where data is distributed and where the data is replicated and duplicated.

Data stored in the virtual disk volumes of the user is separated from a device level. Therefore, data of another user cannot physically or logically intrude the data. Also, it is possible to simply track the data, and a danger range is reduced in terms of information security.

In an exemplary embodiment of the present invention, virtual disk volumes are generated as logical block devices, and thus an access right can be set after a file system is obtained. In plain language (based on Windows operating system (OS)), in a general distributed file system, data is stored in one partition divided into only directories, and the stored data is automatically managed by a metadata server. In other words, a user cannot know a location, and from the viewpoint of a file system, data of several users in one physical partition is classified in only disk tracks but is written and read in a mixed state. Therefore, when only one account is hacked by bypassing a network port of a virtual storage for a specific user, it is possible to obtain data of all other users present in the partition (there are too many hacking algorithms based on this method, and thus only the concept has been described).

However, in an exemplary embodiment of the present invention, respective users correspond to different partitions. Therefore, even when a user uses the same disk as other users, his or her data does not overlap with data of the other users, and thus it is unnecessary to convert filenames into unique filenames such as the aforementioned hash values. In case of need, in order to prevent or track down data leakage, it is possible to strengthen security using an information protection solution, which is used in an existing method, as it is. In other words, without developing and introducing an additional method or security solution for virtualization storage, it is possible to use an information protection solution used in an existing method.

Next, volume rebalancing and a snapshot backup will be described below.

Technology for a balancing technique is a unique function in a distributed file system. Therefore, it will be only described below how effective a virtual storage combined with block devices is in a balancing operation.

Like all the above issues, it is possible to check the flow of data of volumes distributed to respective storage nodes. When data is unbalanced sometimes, that is, when distributed data of user1 is concentrated on one server, the operation of balancing block devices assigned to user1 between storage nodes 1 and 2 can be performed without affecting other volumes. In a general distributed file system, when it is intended to balance data of one user among respective nodes, balancing is performed in partition units. In other words, since data of all users coexist in one volume, the process of analyzing and balancing the data is complicated. (This involves searching metadata to match the metadata with filenames and then moving fragmented files to an appropriate location. This process causes heavy overhead. Therefore, when a node is added, rebalancing is generally performed among all nodes.) Also, it is difficult to know which user has an unbalanced data space (Needless to say, this is possible when data spaces are checked one by one by checking a system command directory capacity, but in practice, it is impossible and inefficient to check data spaces one by one by checking a system command directory capacity).

However, in an exemplary embodiment of the present invention, balancing can be performed at a block device level, so it is possible to reduce unnecessary overhead. Also, capacities of respective block devices are checked and collected by the control center server 300, and thus it is possible to know a data imbalance among nodes according to users. Therefore, in an exemplary embodiment of the present invention, it is possible to know to which block data is replicated, and a snapshot and a backup can be performed at the device level to avoid data duplication.

The above-described exemplary embodiments of the present invention are not only implemented through an apparatus and method, but can also be implemented through a program for executing functions corresponding to configurations of the exemplary embodiments of the present invention or a recording medium storing the program. Such implementation can be easily carried out by those of ordinary skill in the art to which the present invention pertains based on the descriptions of the exemplary embodiments.

While the present invention have been described with reference to certain exemplary embodiments thereof, it will be understood by those of ordinary skill in the art that various changes in form and details may be made therein without departing from the spirit and scope of the invention as defined by the appended claims.

### INDUSTRIAL APPLICABILITY

Exemplary embodiments of the present invention propose a fundamental solution to the risk of loss and infringement of information stored in device volumes, and make it possible to perform a volume snapshot backup excluding duplicated data according to users by assigning user-specific distribution nodes to the device volumes.

Also, it is possible to measure the degree of imbalance in the amount of disk use according to volumes allocated to users, and reduce overhead by performing rebalancing according to the allocated volumes.

In addition, even in the case of data having a different standard of specifications of a node storage, etc. than other data, it is possible to calculate a result of addition based on the same standard. Also, by applying weights to respective factors, data to be considered with priority is reflected in the result of addition and can be disposed in an objectively appropriate environment in a distributed manner.

Further, since data is distributed to storage nodes which use a small amount of resources and processed, it is possible to ensure high performance and high availability by disposing low-specification storage equipment in a distributed manner.

1. An intelligent distributed storage service system connected to at least one user terminal through a network, the system comprising:
a web server configured to receive selection information including a virtual storage capacity necessary for a virtual storage service, the number of storage nodes, storage node types, and a distribution method from the terminal when the terminal requests the virtual storage service;
at least one storage node configured to generate a virtual disk volume according to external control;
a control center server configured to monitor available capacities and usage states of the storage nodes, determine a storage node corresponding to the selection information among the monitored storage nodes, and control the determined storage node to generate the virtual disk volume; and
a database (DB) configured to store information of the storage node and virtual disk volume information of the user.

2. The intelligent distributed storage service system of claim 1, wherein, when the terminal requests the virtual storage service, the web server requests the terminal to input a necessary virtual storage capacity, storage node types to be generated, the number of storage nodes, and a distribution method, and
when the virtual storage capacity, the storage node types, the number of storage nodes, and the distribution method arc input from the terminal, the web server transfers the input information to the control center server.

3. The intelligent distributed storage service system of claim 2, wherein the control center server calculates a capacity required by the respective storage nodes by dividing the input capacity by the number of necessary storage nodes, determines the storage node corresponding to the selection information among storage nodes having capacities 1.5 times or more the capacity required by the respective storage nodes, and controls the determined storage node to generate the virtual disk volume.

4. The intelligent distributed storage service system of claim 3, wherein the control center server calculates values by multiplying an available capacity, a disk input and output (I/O) average ranking, a central processing unit (CPU) usage rate average ranking, a memory usage rate, and a network I/O average ranking of each storage node by weights using the available capacities and the usage states of the storage nodes, adds the values, determines a storage node to configure a virtual storage according to rankings of sums, and controls the determined storage node to generate the virtual disk volume.

5. The intelligent distributed storage service system of claim 2, wherein the control center server selects, from among the storage nodes, a storage node satisfying a condition given below:
[Capacity currently remaining in node]>[Total capacity of virtual storage to be generated/(Number of storage spaces to be generated/Number of replications)](When the number of replications is zero, the division is not performed).

6. The intelligent distributed storage service system of claim 1, wherein the control center server controls the determined storage node to generate the virtual disk volume, and the determined storage node generates the virtual disk volume.

7. An intelligent distributed storage service method connected to at least one user terminal through a network, the method comprising:
requesting, by the terminal, a virtual storage service from a web server;
receiving, by the web server, selection information including a virtual storage capacity necessary for the virtual storage service, a number of storage nodes, storage node types, and a distribution method from the terminal;
calculating, by a control center server, a capacity required by the respective storage nodes by dividing the input virtual storage capacity by the number of necessary storage nodes with reference to the selection information;
determining, by the control center server, a storage node corresponding to the selection information among nodes having capacities 1.5 times or more the capacity required by the respective storage nodes;
controlling, by the control center server, the determined storage node to generate a virtual disk volume; and
generating, by the determined storage node, the virtual disk volume according to the control of the control center server.

8. The intelligent distributed storage service method of claim 7, wherein the determining of the storage node corresponding to the selection information comprises:
calculating values by multiplying an available capacity, a disk input/output (I/O) average ranking, a central processing unit (CPU) usage rate average ranking, a memory usage rate, and a network I/O average ranking of each storage node by weights using available capacities and usage states of the storage nodes, and adding the values; and
determining a storage node having a sum whose ranking is included in rankings of the number of necessary storage nodes as the corresponding storage node.

9. The intelligent distributed storage service method of claim 8, further comprising storing, by the control center server, information on the generated virtual disk volume of the user in a database (DB).

10. The intelligent distributed storage service method of claim 9, wherein the receiving of the selection information by the web server comprises:
when the terminal requests the virtual storage service, requesting the terminal to input a necessary virtual storage capacity, storage node types to be generated, the number of storage nodes, and a distribution method; and
when the virtual storage capacity, the storage node types, the number of storage nodes, and the distribution method are input from the terminal, transferring the input information to the control center server.

11. The intelligent distributed storage service method of claim 8, wherein the calculating values by multiplying an available capacity, a disk I/O average ranking, a CPU usage rate average ranking, a memory usage rate, and a network I/O average ranking of each storage node by weights using the available capacities and the usage states of the storage nodes, and the adding the values comprises calculating the available capacity, the disk I/O average ranking, the CPU usage rate average ranking, the memory usage rate, and the network I/O average ranking using equations given below:
1. Disk free score=(Disk free÷Disk total)×100×Weight 1
2. Disk I/O score=(100−(Disk I/O average ranking÷Total number of storage nodes))×100×Weight 2
3. Network I/O score=(100−(Network I/O average ranking÷Total number of storage nodes))×100×Weight 3
4. CPU usage score=(100−CPU usage average rate)×Weight 4
5. Memory usage score=((Free size+Cached size)÷Total size) average value×100×Weight 5.

12. The intelligent distributed storage service system of claim 2, wherein the control center server controls the determined storage node to generate the virtual disk volume, and the determined storage node generates the virtual disk volume.

13. The intelligent distributed storage service system of claim 3, wherein the control center server controls the determined storage node to generate the virtual disk volume, and the determined storage node generates the virtual disk volume.

14. The intelligent distributed storage service system of claim 4, wherein the control center server controls the determined storage node to generate the virtual disk volume, and the determined storage node generates the virtual disk volume.

15. The intelligent distributed storage service system of claim 5, wherein the control center server controls the determined storage node to generate the virtual disk volume, and the determined storage node generates the virtual disk volume.
